(19) United States
(12) Patent Application Publication
(10) Pub. No.: US 2025/0016025 A1
(43) Pub. Date: Jan. 9, 2025

(54) A SECONDARY CONTROL UNIT FOR A VEHICLE WITH A PRIMARY CONTROL UNIT AND A DATA TRANSMISSION PATH

(71) Applicant: Knorr-Bremse Systeme Fuer Nutzfahrzeuge GmbH, Munich (DE)

(72) Inventors: Jonas Leibbrand, Eberdingen-Nussdorf (DE); Oliver Jundt, Hessigheim (DE); Sabine Clephas, Esslingen (DE); Andreas Schaefers, Oberriexingen (DE)

(21) Appl. No.: 18/711,425

(22) PCT Filed: Nov. 24, 2022
(86) PCT No.: PCT/EP2022/083127

§ 371 Date: May 17, 2024

(30) Foreign Application Priority Data
Nov. 29, 2021 (EP) 21211095.1

(51) Int. Cl. H04L 12/40; B60R 16/023; B60T 17/00; G07C 5/08; H04L 43/0817; H04L 67/12

(52) U.S. Cl. CPC H04L 12/40032; B60R 16/0231; H04L 43/0817; H04L 67/12; B60T 17/00; G07C 5/0808; H04L 2012/40215; H04L 2012/40273

(57) ABSTRACT

A secondary control unit for a vehicle with a primary control unit and a data transmission path, in which the primary control unit is configured to provide first payloads via the data transmission path under a first sender identifier uniquely referring to the primary control unit. The secondary control unit is configured to provide second payloads under a second sender identifier uniquely referring to the secondary control unit via the data transmission path. Furthermore, the secondary control unit is configured to verify a condition and, if the condition is present, to provide substitute payloads under the first sender identifier via the data transmission path, wherein the substitute payloads are the first payloads or payloads related thereto.

### FIELD OF THE INVENTION

The present invention relates to a secondary control unit for a vehicle having a primary control unit and a data transmission path, a data communication network for the vehicle, a method for redundantly providing first payloads in the vehicle, and in particular to a method of split message transmission for redundant systems in automatically operated vehicles.

### BACKGROUND INFORMATION

Control units in electronic data processing systems, machines, buildings, vehicles, aircraft or ships often communicate via common data transmission paths. In particular, these can be wired or wireless bus systems or data communication networks. In vehicles, for example, a data bus and its connected devices form a Controller Area Network (CAN). The devices exchange data in a defined form, namely according to one or more specific protocols. According to such a protocol (such as the CAN 2.0 protocol or the CAN FD protocol), the information is organized in data frames, each of which has a number of predefined fields. Among these, certain fields contain a payload, such as an instruction or a measured value. Fields preceding and following these fields contain, for example, information on the limitation of the data frame (e.g. in a “start of frame” and an “end of frame” field), an identification of the sending control unit, information on the data length and a checksum that can be used to detect errors during transmission. In fieldbuses in particular, the data frames have so-called identifier fields, the values of which define, for example, the sending control unit, one or more receiving devices or a priority of the data frame for its transmission on the bus.

Vehicles operating autonomously at higher levels require safeguarding of processes in the vehicle to increase driving safety. This also applies to the devices and the transmission of data in the data communication network.

In the state of the art, it is known to create suitable redundancies and, in particular, to duplicate control units and/or actuators and communication connections.

An example of such a duplicated configuration can be found in the document WO 2018/237121 A1. It discusses a fault-tolerant autonomous driving system comprising a control unit with several processors. Each of the individually supplied and independently operating processors monitors the others and performs safety functions if failures or errors are detected in the other processors. In particular, each of the processors can individually receive and process sensor data and independently activate peripheral devices.

Document DE 102 43 713 B4 discusses at least two redundantly configured control units, each of which generates an output data instance independently of the other. One of the output data instances is selected in an evaluation and then provided as payload via a data bus.

Problems with conventional solutions predominantly arise in the required duplication of devices, data transmission paths and functions. This not only makes conventional systems more expensive and more complex to manufacture, but also often leads to difficulties due to spatial restrictions.

In particular, there is a need for concepts to introduce redundancies cost-effectively and efficiently into existing architectures.

### SUMMARY OF THE INVENTION

At least part of said problems may be solved by a secondary control unit according to claim 1, a data communication network according to claim 7, a commercial vehicle according to claim 11, a method for redundantly providing first payloads according to claim 12, a method for setting up redundancy according to claim 13 and a storage medium according to claim 14. Further dependent claims define advantageous embodiments of the subject matter of the independent claims.

The present invention relates to a secondary control unit for a vehicle, in particular a commercial vehicle, comprising a primary control unit and a data transmission path. The term control unit should be understood generally as a device configured to provide data on the data transmission path.

The primary control unit is configured to provide or send first payloads via the data transmission path under a first sender identifier that uniquely refers to the primary control unit. The first payloads are intended for other devices or equipment of the vehicle which also communicate via the data transmission path. In particular, the other devices or equipment are advantageously configured to detect and/or receive the first payloads among other data on the data transmission path by the first sender identifier.

The secondary control unit is configured to provide second payloads under a second sender identifier that uniquely refers to the secondary control unit via the data transmission path. Furthermore, the secondary control unit is configured to verify a condition and, if the condition is present, to provide substitute payloads under the first sender identifier via the data transmission path. The substitute payloads are the first payloads, or payloads related thereto.

Advantageously, the primary control unit and the secondary control unit are not integrated, i.e. not combined in one unit. In particular, the first sender identifier and the second sender identifier are different. In embodiments, the primary control unit is also provided for a different task or for a different purpose than the secondary control unit. The primary control unit and the secondary control unit may only be connected by the data transmission path, i.e. have no other means of communication than via the data transmission path.

The first and second payloads and the substitute payloads may, in particular, be data (e.g. from sensors) that is to be provided repeatedly, continuously, or with a certain periodicity. The substitute payloads are advantageously only generated and provided if the first payloads fail on the data transmission path, are not provided, or are not provided as planned. The first payloads do not necessarily comprise all information provided by the primary control unit via the data bus. It does also not necessarily have to be the case that a corresponding substitute payload is provided for each failed or expired first payload. Rather, for example, a frequency at which the substitute payloads are provided and a frequency at which the first payloads are provided may differ.

Accordingly, the condition captures that the primary control unit does not provide the first payloads, or does not provide them as required. The primary control unit does not provide the first payloads, for example, if it does not send the first payloads over a certain period of time, although this would have been expected. For example, the primary control unit does not provide the first payloads as required if it provides the first payloads with an incorrect repetition or sequence rate, or in incorrectly structured data frames.

The secondary control unit is advantageously configured to perform a different function than the primary control unit. In particular, the second payloads may differ from the first payloads in terms of form, content and purpose. However, the functions of the primary control unit and the secondary control unit can be similar, so that processes similar to those in the primary control unit can take place within the secondary control unit. The secondary control unit can be configured to at least partially take over the processes of the primary control unit in the event of a failure of the latter, in order to provide the substitute payloads via the data transmission path. Providing the second payloads is advantageously independent of providing the substitute payloads. It is therefore irrelevant whether the secondary control unit actually provides the second payloads for example in a temporal or causal connection with the first payloads or the substitute payloads. What is important is that the secondary control unit can “usually”, i.e. in a regular operation, provide information with a second sender identifier, uniquely referring to the secondary control unit, via the data transmission path.

The substitute payloads are such that they continue to enable functions that are dependent on the first payloads in devices connected to the data transmission path. In particular, the substitute payloads may be the first payloads themselves, or the substitute payloads may be contentwise the same or equivalent in content to the first payloads such as the primary control unit would have sent or should have sent them. However, the substitute payloads may also comprise only approximately equivalent information to the first payloads. In embodiments, the secondary control unit provides the substitute payloads in the same data formatting as the primary control unit provides the first payloads.

The secondary control unit does not provide the substitute payloads under its own second sender identifier, but under the first sender identifier of the primary control unit. As a result, the devices configured to receive the first payloads from the primary control unit can also detect or receive the substitute payloads. These receiver devices may furthermore be configured to receive information via the data transmission path exclusively, or necessarily, if the information has been provided under the first sender identifier on the data transmission path.

The first payloads, second payloads and substitute payloads may be sent in data packets or data frames with a predetermined structure. The data transmission path may be provided or configured for the transmission of data in specific data frames.

The data transmission path may be configured for serial and/or non-deterministic transmission of information or data. In particular, an arbitration (to control reception) and/or a prioritization (to determine a transmission sequence or avoid collisions) may take place for data frames that is/are related to the sender identifiers. In such cases, the substitute payloads also undergo the same arbitration or prioritization as the first payloads, due to their provision under the first sender identifier.

Optionally, the primary control unit is configured to receive first triggering information and to generate the first payloads based thereon, and the secondary control unit is configured to receive second triggering information and to generate the substitute payloads based thereon.

The triggering information triggers and/or enables the generation of the corresponding payloads in the respective control unit. In particular, the triggering information may be data from sensors. In embodiments, the triggering information does not reach the primary and secondary control units via the data transmission path, but via other channels, for example via fixed signal lines or via wireless communication. However, it is also possible for the trigger data to reach the primary control unit and the secondary control unit in whole or in part via the data transmission path.

Advantageously, the secondary control unit is also configured to generate the second payloads based on the second triggering information. For example, in a control mode, the secondary control unit may generate the second payloads based on data from a sensor connected to the secondary control unit, and, after verifying the condition, the substitute payloads may also be generated based on the data from this sensor. This may be the case in particular if the secondary control unit is configured for a similar task as the primary control unit.

In embodiments, the first triggering information and the second triggering information are partially or completely identical; for example, they may have been generated by the same sensor. In other embodiments, the first triggering information and the second triggering information originate from different sources of the same type (for example from two wheel speed sensors) that measure the same physical quantity, or a physical quantity equivalent or similar for performing functions in the receiving devices (for example, wheel speeds at different wheels of the vehicle). In further embodiments, a source of the first triggering information is different from a source of the second triggering information; for example, one of them may comprise measured values from a radar or lidar sensor, while the other one may comprise measured values from an ultrasonic sensor. In such embodiments in particular, the second payloads may also be very different from the first payloads. The secondary control unit may be configured to perform other functions than, or be technically different from, the primary control unit. However, the second triggering information still allows the generation of, for example, approximately determined first payloads.

Optionally, the secondary control unit is configured to detect first payloads provided under the first sender identifier via the data transmission path.

The condition may then be based on an absence (in particular, the condition may consist in the absence itself) or on an expiry (e.g. a time-out or an invalidity) of first payloads provided under the first sender identifier via the data transmission path.

For example, the secondary control unit may detect an absence of first payloads for more than a predefined period of time on the data transmission path, or a time-out of first payloads, or of corresponding data frames, from the primary control unit. In general, the condition may be based on a detection of the first payloads by the secondary control unit.

Optionally, the secondary control unit has a separate data connection to the primary control unit and is configured to receive a signal from the primary control unit via the separate data connection, wherein the condition is then based on a reception of the signal by the secondary control unit. This feature may be provided in addition to the detection of the first payloads on the data transmission path as described above.

The signal may, for example, be a heartbeat or another self-diagnostic signal sent from the primary control unit to the secondary control unit. The condition may be dependent on an information content of the signal or, in particular, comprise an absence of the signal. The signal can also be a response signal to a request signal sent regularly from the secondary control unit to the primary control unit. The request signal can be sent via the separate data connection and/or via the common data transmission path.

Optionally, the data transmission path comprises at least one (data) bus. There may be one or more wireless buses or one or more wired buses. The at least one bus can be a data bus, address bus, or control bus, for example. The at least one bus may also be located within a processor or within an electronic data processing unit. In particular, however, the at least one bus may be part of a serial data communication network, a fieldbus network, a Controller Area Network (CAN) or a Controller Area Network with Flexible Data-Rate (CAN FD) of the vehicle. Particularly advantageous embodiments comprise only one bus.

Optionally, the first sender identifier and the second sender identifier may each comprise at least part of an identifier field (ID) according to a bus protocol. The identifier field may comprise subfields, the content of which defines a priority, a parameter group number (PGN) and/or a source identifier in the narrower sense. The data frames and their transmission can be based on a specific network protocol, such as SAE J1939.

Embodiments further relate to a data communication network for a vehicle. The data communication network comprises at least one (data) bus, a primary control unit which is configured to provide first payloads on the at least one bus under a first sender identifier uniquely referring to the primary control unit, and a secondary control unit which is configured as described above.

Optionally, in the data communication network, the primary control unit is an electronic control unit for a first brake unit of the vehicle, and the secondary control unit is an electronic control unit for a second brake unit of the vehicle.

In embodiments, the first brake unit is configured to brake a first wheel and the second brake unit is configured to brake a second wheel of the vehicle, wherein the second wheel is different from the first wheel. The first and second wheels may be located on the same axle of the vehicle, for example on different sides of the vehicle.

In other embodiments, the first and second brake units are provided for braking the same wheel.

Optionally, in the event that the primary control unit generates the first payloads on the basis of first triggering information, and the secondary control unit generates the substitute payloads (and optionally also the second payloads) on the basis of second triggering information, the first triggering information are measured values of a first wheel speed sensor, and the second triggering information are measured values of a second wheel speed sensor. The first wheel speed sensor may be different from the second wheel speed sensor, or the first wheel speed sensor may be identical to the second wheel speed sensor. If different wheel speed sensors are involved, they may be assigned to a single or two different wheels of the vehicle.

The primary control unit may provide measured values of wheel speeds via a bus, for example to a gearshift of the vehicle. The gearshift may use the measured wheel speed values to engage the gears correctly. Further control units of the bus may be configured to receive information provided via brake units.

In embodiments, provision may be made to connect a single wheel speed sensor to both the primary and secondary control units, wherein the wheel speed sensor and the primary and secondary control units are assigned to a specific wheel of the vehicle. However, other embodiments deviate from this structure with regard to the number and assignment of the wheel speed sensors, and with regard to the assignment of the primary and secondary control unit. In embodiments, a first wheel speed sensor may thus send wheel speeds of a first wheel to the primary control unit assigned to a brake unit of the first wheel, and a second wheel speed sensor may send wheel speeds of a second wheel to the secondary control unit assigned to a brake unit of the second wheel. The secondary control unit is then configured to provide, by the substitute payloads, an approximation of the failed first payloads on the data transmission path or on the at least one bus.

Optionally, the condition comprises an internal error in the primary control unit, a failure of a power supply of the primary control unit, an error in a control of the primary control unit, or a failure of a sensor that is configured to send measurement data to the primary control unit to generate the first payloads.

Embodiments further relate to a commercial vehicle with a data communication network, or with a secondary control unit, of the type described above. With regard to a layered architecture, the data communication network may basically be implemented in any layer (such as in an application, object, transmission or bit transmission layer).

Embodiments further relate to a method for redundantly providing first payloads in a vehicle. The vehicle comprises a data transmission path, a primary control unit configured to provide first payloads via the data transmission path under a first sender identifier uniquely referring to the primary control unit, and a secondary control unit configured to provide second payloads via the data transmission path under a second sender identifier uniquely referring to the secondary control unit. The method comprises determining a presence of a condition; and providing, if the condition is present and by the secondary control unit, substitute payloads under the first sender identifier via the data transmission path.

Embodiments further relate to a method for setting up a redundancy in a data communication network of a vehicle, wherein the data communication network comprises at least one bus as well as a first control unit and a second control unit, and wherein the first control unit is configured to provide first payloads via the at least one bus under a first sender identifier uniquely referring to the first control unit, and wherein the second control unit is configured to provide second payloads via the at least one bus under a second sender identifier uniquely referring to the second control unit. In particular, it is advantageous if the first control unit and the second control unit perform related tasks (for example, a control process in a brake unit in each case), and/or if the first payloads comprise, for example, data that is used or generated in the first control unit, and the second control unit uses or generates the same or similar data.

This method then comprises configuring the second control unit to verify a condition and, if the condition is present, to provide substitute payloads under the first sender identifier on the at least one bus. The substitute payloads are the first payloads, or payloads related thereto. With regard to the condition, the second control unit may be configured to detect an absence of first payloads on the data transmission path, or it may be configured to be requested by the first control unit or by a further component of the vehicle to provide the substitute payloads on the at least one bus.

Embodiments also relate to a storage medium with program code stored thereon, intended for a data processing machine and configured to cause the data processing machine to perform one of the methods described above.

Important aspects of the secondary control unit and the data communication network can also be summarized as follows.

The presented method of “joint message transmission” serves to divide the responsibility between the primary control unit and the secondary control unit for the transmission of a message with the same sender identifier in a vehicle.

In contrast to redundancies in the prior art, in which the payload itself is usually generated redundantly, the secondary control unit and the data communication network presented here are primarily concerned with the sender identifier, i.e. the declaration of the transmitting device. In conventional redundancy solutions, two or more control units are configured to provide all data exclusively with the same sender identifier on the data transmission path (for example, by jointly generating a payload, for example by individual determination and a selection procedure, and placing it-possibly via an intermediate selection device-on a data bus), or at least one further control unit is configured to generate a payload on an auxiliary basis, in addition to a first control unit, and then to provide the payload on the data transmission path using the sender identifier specific to this further control unit. In contrast, the secondary control unit described above is advantageously only used on an auxiliary basis in order to provide substitute payloads on the data transmission path on behalf of the primary control unit (i.e. with the first sender identifier) for the first payloads provided by the primary control unit during normal operation.

The primary control unit and the secondary control unit advantageously have different tasks or serve different purposes when transmitting first or second payloads, respectively. However, the primary and secondary control units may each be part of a control unit cluster with similar or related tasks (e.g. parts of a redundant braking system or of a redundant steering system). Control units in this control unit cluster may have identical interfaces to the data transmission path or to other control units or tools.

In embodiments, the secondary control unit is configured to check, for example at regular intervals, whether first payloads are being provided on the data transmission path. The condition for providing substitute payloads by the secondary control unit may comprise, in particular, detecting a time-out of the first payloads on the data transmission path.

The secondary control unit may also be configured to request providing the first payloads from the primary control unit via the data transmission path.

In embodiments, the primary control unit is optionally connected to the secondary control unit via a separate data connection, and exchanges data with the secondary control unit. In parallel, the primary and secondary control units provide the first and second payloads, respectively, to other control units, such as an engine control unit, a transmission control unit or a diagnostic tool, via the data transmission path. The data exchanged between the primary control unit and the secondary control unit may, for example, be status information indicating a general health status of the primary control unit. From this, it can be directly or indirectly apparent to the secondary control unit whether the first payloads, e.g. the information for the engine sent via a CAN, is transmitted by the primary control unit, or whether this is not the case. The information exchanged between the primary control unit and the secondary control unit may also comprise an explicit signal requesting the secondary control unit to start transmitting the “common message”, i.e., the substitute payloads. The decision whether to share the transmission of a particular message between multiple control units may depend on the configuration of a data set.

Situations in which the primary control unit no longer provides the first payloads on the data transmission path may comprise, for example:
that the primary control unit is no longer supplied with electricity,
that the primary control unit is unable to transmit the first payloads due to a technical defect,
that the primary control unit or external components (e.g. a sensor whose data forms the first payloads) is or are in an error state that does not allow the required information transmitted with the CAN message to be updated, or
that the primary control unit is no longer responsible for updating the CAN message information; in particular, the primary control unit may have been caused by an error in another component of the vehicle, or, in order to increase the safety of the vehicle, by another component, to no longer provide the first payloads.

If this is the case, the secondary control unit has the option of intervening and starting to transmit substitute payloads for the first payloads. The secondary control unit sends the substitute payloads with the same sender identifier, i.e. message ID, as the primary control unit. The substitute payloads comprise the same or equivalent content as the first payloads that the primary control unit would have provided.

The change from the primary control unit to the secondary control unit can thus take place in particular due to
a message timeout, detected, for example, by the secondary control unit, and/or
a requested change to the secondary control unit (e.g. by exchanging status information between the primary control unit and the secondary control unit).

Advantages of the secondary control unit or the data communication network, in particular compared to the distribution of the same information to different message IDs in conventional systems, comprise in particular that the secondary control unit behaves at least partially like a known or non-redundant component, namely like the primary control unit, in relation to other control units in the vehicle. The concept presented is also suitable for retrofitting an existing vehicle architecture. The vehicle architecture may be configured for manual driving, for example, but is to be used for autonomous driving tasks. Retrofitting then comprises configuring a suitable control unit as a secondary control unit. This requires only minimal changes on the hardware and software side, and it may significantly reduce the effort required to introduce or ensure redundancy, for example for the following reasons:
No software adaptations are required for non-redundant components in the system (especially for devices configured to receive the first payloads).
In embodiments, the new component serving as redundancy (representing the secondary control unit) does not require any changes to its interface to the data transmission path or CAN. Other control units of the vehicle system, but also externally connected tools such as diagnostic devices for end-of-line testers, are therefore suitable as secondary control units.
In embodiments, no or only minor hardware changes to the data communication network or CAN are required.
Redundancy can be limited to hardware/software within an existing system that is relevant to security for the ODD (Operational Design Domain).
Setting up a control unit as the secondary control unit offers high backwards compatibility of hardware and software for many components in the vehicle, a comparison of use cases for manual and fully automated driving, and a reduction in product variants.

The embodiments of the present invention will be better understood from the following detailed description and accompanying drawings of the various embodiments, which, however, should not be construed as limiting the disclosure to the specific embodiments, but are merely for purposes of explanation and understanding.

### BRIEF DESCRIPTIONS OF THE DRAWINGS

FIG. 1 shows a secondary control unit according to the present invention.

FIG. 2 illustrates a function of the secondary control unit.

FIG. 3 shows an embodiment and illustrates advantages of the secondary control unit in a data communication network.

FIG. 4 illustrates advantages of the secondary control unit in another data communication network.

FIG. 5 shows steps of a method for redundantly providing first payloads in a vehicle.

FIG. 6 shows further details of an embodiment of the method.

### DETAILED DESCRIPTION

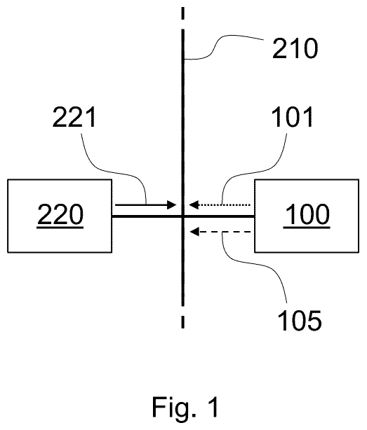

FIG. 1 shows a secondary control unit 100 for a vehicle, which is connected to a data transmission path 210 of the vehicle. In addition, a primary control unit 220 of the vehicle is also connected to the data transmission path 210. The primary control unit 220 is configured to perform a first task, and for this purpose is configured to provide first payloads 221 via the data transmission path 210 under a first sender identifier which uniquely refers to the primary control unit 220. The secondary control unit 100 is provided for a second task, which is advantageously different from the first task. For this purpose, the secondary control unit 100 is configured to provide second payloads 101 under a second sender identifier which uniquely refers to the secondary control unit 100 via the data transmission path 210. Providing the first payloads 221 and the second payloads 101 can take place, for example, repeatedly at predetermined time intervals, or on request, for example by another component of the vehicle (in particular by communication via the data transmission path), or according to other preconditions; in particular, the primary control unit can also differ from the secondary control unit in this respect. The transmission of information via the data transmission path 210 may comprise a prioritizing.

The secondary control unit 100 is configured to verify a condition comprising a failure or an interruption in providing the first payloads 221 by the primary control unit 220. The secondary control unit 100 is further configured to provide substitute payloads 105 under the first sender identifier via the data transmission path 210 if the condition is present. The substitute payloads 105 are intended as a substitute for the first payloads 221. They are either the first payloads 221 themselves (i.e., they comprise the information which the primary control unit 220 should have transmitted as first payloads 221), or they represent payloads related thereto, such as comparable measured values, or information approximating that of the first payloads 221.

In embodiments, the primary control unit is configured to provide further substitute payloads for the second payloads on the data transmission path; in particular, a reciprocal takeover of tasks can therefore take place, corresponding to a failure either of the primary control unit or of the secondary control unit. It is also possible to include further control units.

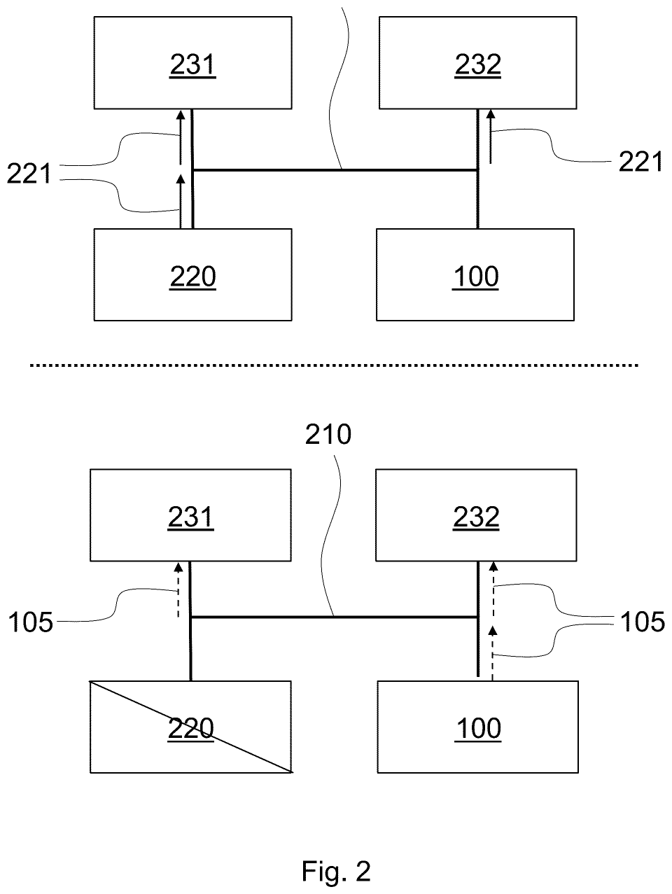

FIG. 2 illustrates a mode of operation of the secondary control unit 100. In an upper part of the figure, an operating situation is shown in which the primary control unit 220 provides the first payloads 221 under the first sender identifier on the data transmission path 210. The first payloads 221 are received by a first receiving device 231 and by a second receiving device 232, via the data transmission path 210. The first receiving device 231 and the second receiving device 232 select information from the data transmission path 210 based on a sender identifier. A transmission on the data transmission path 210 may be subject to a prioritization that depends on the first sender identifier.

In a lower portion of the figure, the primary control unit 220 fails to provide the first payloads 221 on the data transmission path 210. The secondary control unit 100 has verified a condition that causes it to send substitute payloads 105 for the first payloads 221. Illustrated is the provision of the substitute payloads 105 on the data transmission path 210 under the first sender identifier by the secondary control unit 100.

The condition may, for example, be a request, coming e.g. from the primary control unit 220 or from another component of the vehicle. Depending on the embodiment, the request may have reached the secondary control unit 100 via the data transmission path 210 and/or via a separate data connection. However, the condition may also comprise that the first payloads 221 have not been provided on the data transmission path 210 for a certain time, due to the failure of the primary control unit 220. The secondary control unit 100 may be configured to verify this, as a condition or as part of the condition, and to start providing the substitute payload 105 after a certain time, for example. Further, the condition may be based at least in part on a functional diagnosis of the primary control unit 220. For example, the primary control unit 220 and the secondary control unit 100 may be configured for transmitting information to the secondary control unit 100 regarding a correct functioning of the primary control unit 220. This can be done via the data transmission path 210, or via a separate data connection between the primary control unit 220 and the secondary control unit 100.

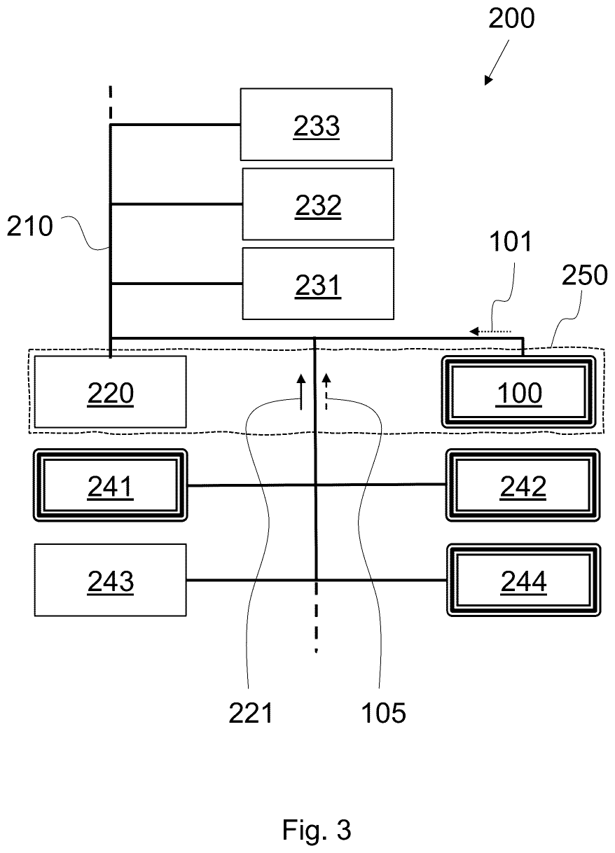

FIG. 3 shows an embodiment and illustrates advantages of the secondary control unit 100, or an implementation of redundancy by the secondary control unit 100, in a data communication network 200. The data communication network 200 can be, for example, a CAN or a CAN-FD.

The data transmission path 210 here is a bus, via which information from a plurality of control devices 100, 220, 241, 242, 243, 244 is provided in a form of data frames. The data frames each have a sender identifier or ID field. The sender identifier basically assigns the information, or the data frame, to the control unit 100, 220, 241, 242, 243, 244 which has provided the data frame on the bus 210.

The control units 100, 220, 241, 242, 243, 244 comprise the primary control unit 220, which may be a first brake control unit, for example, and the secondary control unit 100, which may be a second brake control unit, for example. As further control units, this embodiment comprises a first control unit for autonomous driving 241 and a second control unit for autonomous driving 242, as well as a first steering control unit 243 and a second steering control unit 244. The control units 100, 220, 241, 242, 243, 244 in a similar task area may also be set up mutually as primary control units and secondary control units, in the disclosed sense. The secondary control unit 100, the control units for autonomous driving 242, 243, and the second steering control unit 244 may have already been introduced with a view to autonomous driving, for example by an only partially carried out retrofitting.

In the present embodiment, the primary control unit 220 and the secondary control unit 100 form a control cluster 250, and thus perform similar tasks. For example, the primary control unit 220 may be configured to control a brake actuator for a first wheel of the vehicle, and the secondary control unit 100 may be configured to control a brake actuator for a second wheel of the vehicle. The first wheel and the second wheel, and/or the brake actuator for the first wheel and the brake actuator for the second wheel, may also be identical.

The first payloads 221 may, for example, be continuously updated wheel speeds of the first wheel, which the primary control unit 220 receives from a correspondingly configured first wheel speed sensor. The primary control unit 220 may itself perform a function based on the wheel speeds of the first wheel speed sensor.

The second payloads 101 may, for example, be continuously updated wheel speeds of the second wheel, which the secondary control unit 100 receives from a correspondingly configured second wheel speed sensor. The secondary control unit 100 may also itself perform a function based on the wheel speeds of the second wheel speed sensor.

The primary control unit 220 is configured to provide the wheel speeds of the first wheel speed sensor as first payloads 221 under the first sender identifier on the bus 210. The sender identifier simultaneously defines a prioritization (in order to determine a sequence for information that is to be provided on the bus 210 in a time-colliding manner) for the first payloads 221.

Further devices 231, 232, 233 are connected to the bus 210, each of which is configured for a function which requires information about wheel speeds. In the present embodiment, these devices 231, 232, 233 are an engine device 231 of the vehicle, a gearshift device 232 of the vehicle, and a diagnostic device 233. The devices 231, 232, 233 are configured to receive the first payloads 221, and thus the wheel speeds, via the bus 210. In particular, the devices 231, 232, 233 may be configured to recognize and receive the first payloads 221 based on the first sender identifier; in all devices on the bus 210, but in particular in the devices 231, 232, 233, at least a reception of the sender identifier and an arbitration may therefore take place for data frames on the bus 210.

Providing the substitute payload 105 under the first sender identifier by the secondary control unit 100 leaves both prioritization and arbitration unchanged. Regarding their transmission via the bus 210, the substitute payloads 105 are thus treated in all respects as if they had been provided by the primary control unit 220.

Setting up or configuring a control unit to form a secondary control unit 100 of the type presented here thus offers a particular advantage if redundancy is to be created in an already existing CAN, and suitable control units are available to serve as primary control unit 220 and as secondary control unit 100. In particular, such a configuring may comprise reprogramming one of these control units to serve as the secondary control unit 100. In embodiments, the bus 210, but also the other devices 231, 232, 233 require no or only minor adaptation; for example, existing engine and/or transmission software may be retained in the adaptation process.

Based on the present embodiment, a function of the secondary control unit 100 may be explained using the following example scenario:

The primary control unit 220 and the secondary control unit 100, which are two individual brake control units, are connected to a public CAN bus 210 and/or connected to each other via a private CAN line, and exchange data about their status. The primary control unit 220 sends first payloads 221 about the wheel speed to the public CAN bus 210, which is used by the transmission device 232 to make decisions about a gear selection. Suddenly, the wheel speed sensor information becomes unavailable to the primary control unit 220 due to an electrical connection problem with a wheel speed sensor. The problem deteriorates the health of the primary brake system and stops the transmission of the wheel speed information on the public CAN bus 210, and the secondary control unit 100 is informed via the private CAN line. Since the transmission of the wheel speed information is configured to be shared by the primary control unit 220 and the secondary control unit 100, and there is a redundant connection of the secondary control unit 100 to the same wheel speed sensor, the transmission of the wheel speed information from the secondary control unit 100 continues immediately with the same sender identifier which the primary control unit 220 has been using previously.

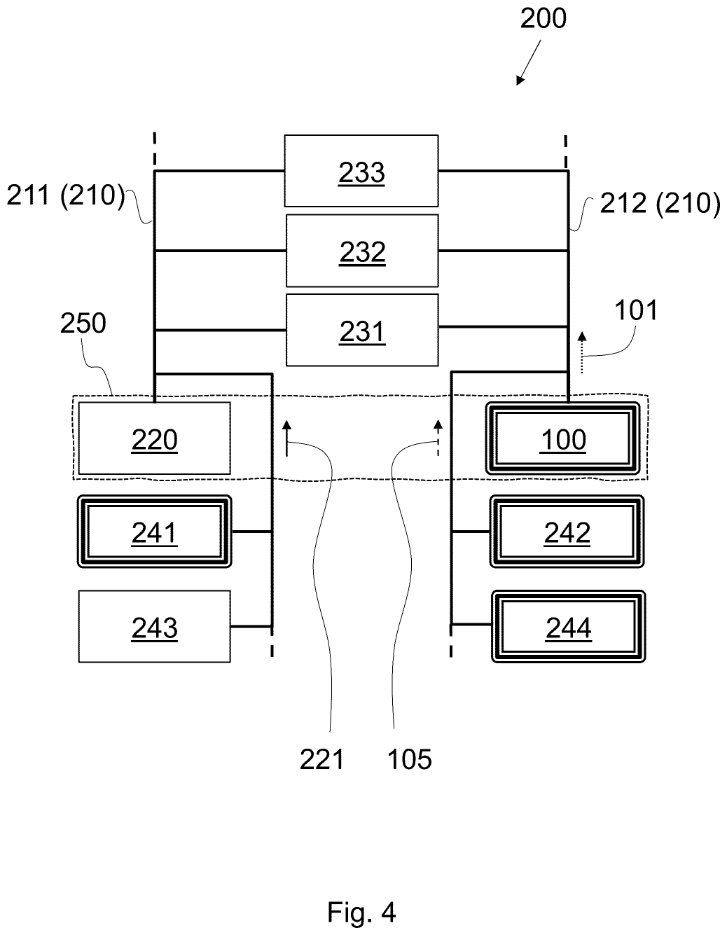

FIG. 4 illustrates advantages of the secondary control unit 100 in a further data communication network 200. In this data communication network 200 there are two separate buses 211, 212. The architecture shown here can occur in particular in a vehicle already configured for autonomous driving.

The primary control unit 220 (for example, a first electronic control unit of a braking device), a primary autonomous driving control unit 241, and a primary steering control unit 243 are each connected to a first bus 211. The secondary control unit 100 (which may be an electronic control unit of a braking device), a secondary autonomous driving control unit 242, and a secondary steering control unit 244 are each connected to a second bus 212. Both buses 211, 212 also each have connections to an engine device 231, a gearshift device 232, and a diagnostic device 233. These devices 231, 232, 233 are thus each connected to both buses 211, 212.

Conventional systems with a structure analogous to this embodiment stipulate that each control unit provides information with its own sender identifier on the respective bus. Even in such a system, however, configuring features of the secondary control unit 100, for example as part of a retrofit or upgrade of the system, can prove advantageous: By providing the substitute payloads 105 under the first sender identifier, the substitute payloads 105 can also be treated in the same way as the first payloads 221 within the devices 231, 232, 233 formed to receive the latter. In addition, there is again the advantage that the substitute payloads 105 are treated in the same way as the first payloads 221 with regard to prioritization and arbitration.

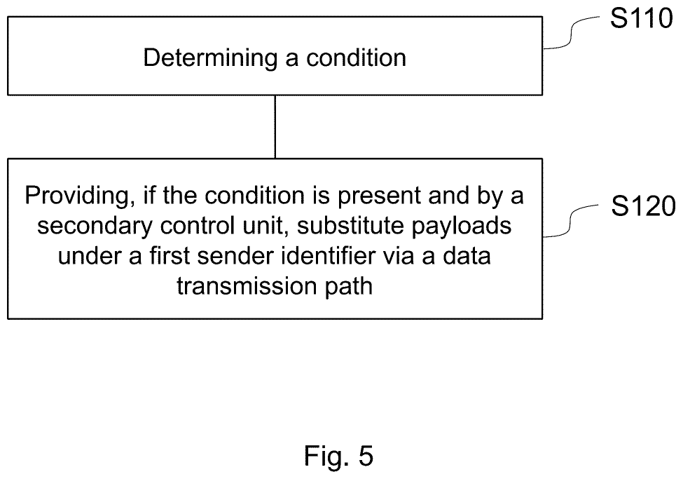

FIG. 5 shows steps of a method for redundantly providing first payloads 221 in a vehicle. The vehicle comprises a data transmission path 210 (such as a bus), a primary control unit 220 configured to provide the first payloads 221 via the data transmission path 210 under a first sender identifier uniquely referring to the primary control unit 220, and a secondary control unit 100 configured to provide second payloads 101 via the data transmission path 210 under a second sender identifier uniquely referring to the secondary control unit 100.

The method comprises determining S110 a condition by the secondary control unit 100, and, if the condition is present, providing S120 substitute payloads 105 under the first sender identifier via the data transmission path 210 by the secondary control unit 100, wherein the substitute payloads 105 are the first payloads 221 or comprise information related thereto.

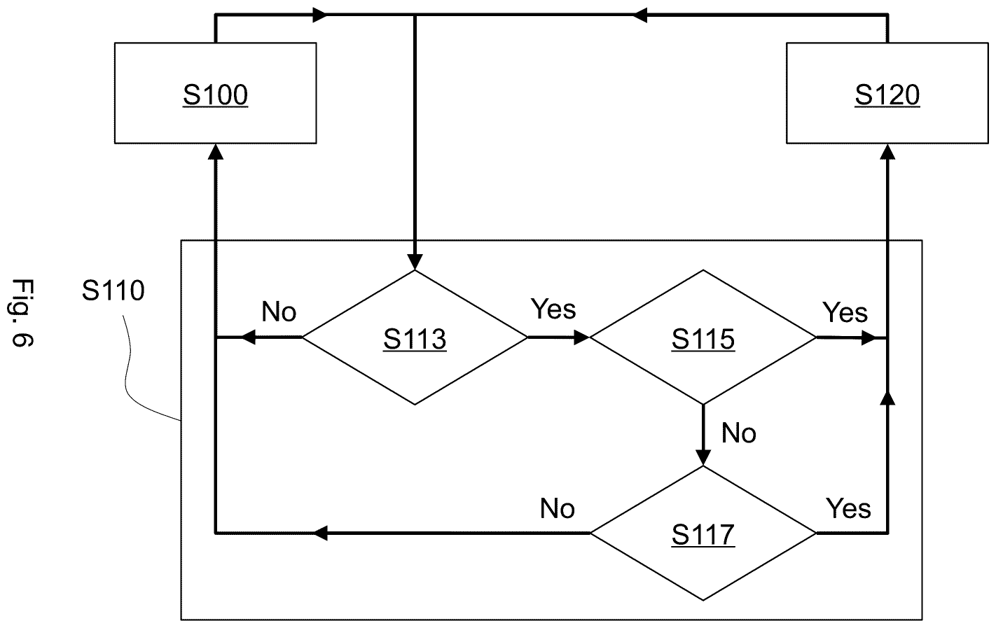

FIG. 6 shows further details for an embodiment of the method of FIG. 5. In particular, aspects of determining S110 the condition are shown in more detail here.

In a normal or control mode, a first payload 221 is provided S100 on the data transmission path 210 by the primary control unit 220. On the data transmission path 210, the first payloads 221 and a plurality of information from further control units 100, 241, 242, 243, 244 are provided each under their respective sender identifiers in a serial sequence determined by a prioritization.

For determining S110 the condition, in this embodiment a first deciding S113 is carried out as to whether first payloads 221 have been assigned or defined at all, i.e. whether it is actually stipulated that one or more pieces of information from the primary control unit 220 are, if necessary, to be replaced by the secondary control unit 100. Such an assignment may, for example, be made beforehand in form of some data set. However, first payloads 221 which are to be replaced may also be determined in some other way. The primary control unit 220 may be configured to provide, in addition to the first payloads 221, some other information about the data transmission path 210 which is not to be replaced. The deciding S113 may comprise checking the sender identifier of the information.

If first payloads 221 are defined, a verifying S115 is carried out in this embodiment as to whether the first payloads 221 have not been provided for a certain time via the data transmission path 210 (case of time-out). This may be, for example, due to the fact that the primary control unit 220 has not sent the first payloads 221 at all, or that the primary control unit 220 has stopped providing S100 the first payloads 221. If there is such a time-out, the condition is considered to be present, and the secondary control unit 100 starts providing substitute payloads 105.

If, on the other hand, there is no such time-out, a further deciding S117 is carried out as to whether there is a request to the secondary control unit 100 for providing the substitute payloads 105. If this is the case, the secondary control unit 100 also provides the substitute payloads 105. If this is not the case, it may be stipulated that the first payloads 221 are no longer tracked for a certain time for the purpose of determining S110 the condition.

For example, for the embodiment illustrated here, it may be that the primary control unit 220 has not been powered from the beginning due to a malfunction. The secondary control unit 100 may detect a lack of information on the CAN bus, and then send the substitute payloads 105 under the sender identifier of the primary control unit 220.

The features of the invention disclosed in the description, the claims and the figures may be essential for the realization of the invention either individually or in any combination.

### THE LIST OF REFERENCE SYMBOLS IS AS FOLLOWS

100 secondary control unit
101 second payloads
105 substitute payloads
210, 211, 212 Data transmission path/(data) buses
220 primary control unit
221 first payloads
231-233, 241-244 further devices connected via the data transmission path
250 control cluster
S110, S113, S115, S117, S120 Steps of a method

1-14. (canceled)

15. A secondary control unit for a vehicle, comprising:
a primary control unit and a data transmission path, wherein the primary control unit is configured to provide first payloads via the data transmission path under a first sender identifier uniquely referring to the primary control unit;
wherein the secondary control unit is configured to perform the following:
providing second payloads, under a second sender identifier uniquely referring to the secondary control unit, via the data transmission path;
verifying a condition; and
providing, if the condition is present, substitute payloads under the first sender identifier via the data transmission path, wherein the substitute payloads are the first payloads or payloads related thereto.

16. The secondary control unit of claim 15, wherein the primary control unit is configured to receive first triggering information and to generate the first payloads based thereon, and wherein the secondary control unit is configured to receive second triggering information and to generate the substitute payloads based thereon.

17. The secondary control unit of claim 15, wherein the secondary control unit is configured to detect first payloads provided under the first sender identifier via the data transmission path, and wherein the condition is based on an absence of first payloads provided under the first sender identifier via the data transmission path.

18. The secondary control unit of claim 15, wherein the secondary control unit has a separate data connection to the primary control unit and is configured to receive a signal from the primary control unit via the separate data connection, and wherein the condition is based on a reception of the signal by the secondary control unit.

19. The secondary control unit of claim 15, wherein the data transmission path includes at least one bus.

20. The secondary control unit of claim 19, wherein the first sender identifier and the second sender identifier each include at least part of an identifier field according to a bus protocol.

21. A data communication network for a vehicle, comprising:
at least one bus; and
a primary control unit and a data transmission path, and configured to provide first payloads on the at least one bus under a first sender identifier uniquely referring to the primary control unit; and
a secondary control unit configured to perform the following:
providing second payloads, under a second sender identifier uniquely referring to the secondary control unit, via the data transmission path;
verifying a condition; and
providing, if the condition is present, substitute payloads under the first sender identifier via the data transmission path, wherein the substitute payloads are the first payloads or payloads related thereto, wherein the data transmission path includes at least one bus.

22. The data communication network of claim 21, wherein the primary control unit includes an electronic control unit for a first brake unit of the vehicle, and wherein the secondary control unit includes an electronic control unit for a second brake unit of the vehicle.

23. The data communication network of claim 21, wherein the primary control unit is configured to receive first triggering information and to generate the first payloads based thereon, wherein the secondary control unit is configured to receive second triggering information and to generate the substitute payloads based thereon, and
wherein the first triggering information are measured values of a first wheel speed sensor and the second triggering information are measured values of a second wheel speed sensor, wherein the first wheel speed sensor is different from the second wheel speed sensor, or the first wheel speed sensor is identical to the second wheel speed sensor.

24. The data communication network of claim 21, wherein the condition includes one of the following:
an internal error in the primary control unit,
a failure of a power supply to the primary control unit,
an error in a control of the primary control unit, and
a failure of a sensor configured to send measurement data to the primary control unit to generate the first payloads.

25. A commercial vehicle, comprising:
a data communication network for a vehicle, including:
at least one bus; and
a primary control unit and a data transmission path, and configured to provide first payloads on the at least one bus under a first sender identifier uniquely referring to the primary control unit; and
a secondary control unit configured to perform the following:
providing second payloads, under a second sender identifier uniquely referring to the secondary control unit, via the data transmission path;
verifying a condition; and
providing, if the condition is present, substitute payloads under the first sender identifier via the data transmission path, wherein the substitute payloads are the first payloads or payloads related thereto, wherein the data transmission path includes at least one bus.

26. A method for redundantly providing first payloads in a vehicle, the method comprising:
determining a condition, wherein the vehicle includes a data transmission path, a primary control unit configured to provide the first payloads under a first sender identifier uniquely referring to the primary control unit via the data transmission path, and a secondary control unit configured to provide second payloads under a second sender identifier uniquely referring to the secondary control unit via the data transmission path; and
providing, if the condition is present, and by the secondary control unit, substitute payloads under the first sender identifier via the data transmission path, wherein the substitute payloads are the first payloads or payloads related thereto.

27. A method for setting up redundancy in a data communication network of a vehicle, the method comprising:
configuring the second control unit to verify a condition, wherein the data communication network includes at least one bus and a first control unit and a second control unit, and wherein the first control unit is configured to provide first payloads via the at least one bus under a first sender identifier uniquely referring to the first control unit, and wherein the second control unit is configured to provide second payloads via the at least one bus under a second sender identifier uniquely referring to the second control unit; and
providing, if the condition is present, substitute payloads under the first sender identifier via the at least one bus, wherein the substitute payloads are the first payloads or payloads related thereto.

28. A non-transitory computer readable storage medium having a computer program, which is executable by a processor, comprising:
a program code arrangement having program code for redundantly providing first payloads in a vehicle, by performing the following:
determining a condition, wherein the vehicle includes a data transmission path, a primary control unit configured to provide the first payloads under a first sender identifier uniquely referring to the primary control unit via the data transmission path, and a secondary control unit configured to provide second payloads under a second sender identifier uniquely referring to the secondary control unit via the data transmission path; and
providing, if the condition is present, and by the secondary control unit, substitute payloads under the first sender identifier via the data transmission path, wherein the substitute payloads are the first payloads or payloads related thereto.
